(19) United States
(12) Patent Application Publication
(10) Pub. No.: US 2016/0291747 A1
(43) Pub. Date: Oct. 6, 2016

(54) ASSET POSITIONING ON LARGE TOUCH-SCREEN DISPLAYS

(71) Applicant: PRYSM,INC, San Jose, CA (US)

(72) Inventor: Brandon FISCHER, Carmel, IN (US)

(21) Appl. No.: 14/675,590

(22) Filed: Mar. 31, 2015

(51) Int. Cl. G06F 3/041

(52) U.S. Cl. CPC G06F 3/0412; G06F 2203/04104

(57) ABSTRACT

One embodiment of the present invention sets forth a method for displaying content on a display surface. The method includes receiving an input associated with a target location on the display surface corresponding to a region associated with a parent asset that resides at least partially within a render space and is displayed at a first display location on the display surface. The method further includes, in response to receiving the input, determining a first spawn location within the render space from one or more possible spawn locations that are available and are associated with the parent asset and the target location and causing a spawn asset to be displayed at a second display location on the display surface that corresponds to the first spawn location, wherein the first spawn location is closer to a first edge of the parent asset than any of the other one or more possible spawn locations.

### BACKGROUND OF THE INVENTION

1. Field of the Invention

Embodiments of the present invention relate generally to large displays and, more specifically, to asset positioning on large gesture-sensitive screen displays.

2. Description of the Related Art

Large multi-touch display walls combine the intuitive interactive capabilities of touch-screen technology with the immersive display features of large screens. Large multi-touch display walls allow presenters to display a multitude of assets, such as images, videos, documents, and presentation slides, and also interact with these assets by touching or making hand gestures near the assets. Touch or gesture-based interactions may include dragging assets to reposition them on the screen, tapping assets to display menu options, swiping assets to page through documents, or using pinch gestures to resize assets. However, when the display wall is large in size, the presenter may obscure the displayed content, particularly when new menus or assets are first displayed on the screen. Additionally, new menus and assets first displayed may obscure previously displayed assets.

As the foregoing illustrates, what would be useful is a more effective approach to positioning assets on large touch-screen displays.

### SUMMARY OF THE INVENTION

One embodiment of the present invention sets forth a method for displaying content on a display surface. The method includes receiving an input associated with a target location on the display surface corresponding to a region associated with a parent asset that resides at least partially within a render space and is displayed at a first display location on the display surface. The method further includes, in response to receiving the input, determining a first spawn location within the render space from one or more possible spawn locations that are available and are associated with the parent asset and the target location and causing a spawn asset to be displayed at a second display location on the display surface that corresponds to the first spawn location, wherein the first spawn location is closer to a first edge of the parent asset than any of the other one or more possible spawn locations.

At least one advantage of the disclosed embodiments is that a newly spawned asset may be displayed at more optimized locations on a gesture-sensitive screen display that avoids obscuring previously displayed assets, prevents a user from obscuring displayed assets when interacting with assets via touch- or gesture-based input, and facilitates access by a user.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a display system configured to implement one or more aspects of the present invention;

FIG. 2 is a schematic diagram of a display tile configured to implement one or more aspects of the present invention;

FIG. 3 is a block diagram illustrating the operation of the display system of FIG. 1, according to one embodiment of the present invention;

FIG. 4 is a conceptual diagram illustrating a display surface of the display wall of FIG. 1 and a corresponding render space, according to one embodiment of the present invention;

FIGS. 5A and 5B illustrate an example of the operation of the display system in FIG. 1 in response to user touch or gesture-based input, according to one embodiment of the present invention;

FIGS. 6A and 6B illustrate an example of the operation of the display system in FIG. 1 in response to user touch or gesture-based input, according to another embodiment of the present invention;

FIGS. 7A and 7B illustrate the operation of the display system in FIG. 1 when an active asset and an inactive asset are displayed thereby, according to one embodiment of the present invention;

FIGS. 8A and 8B illustrate the operation of the display system in FIG. 1 when multiple active assets are displayed thereby, according to one embodiment of the present invention; and

FIG. 9 sets forth a flowchart of method steps for positioning one or more assets on a display, according to one embodiment of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

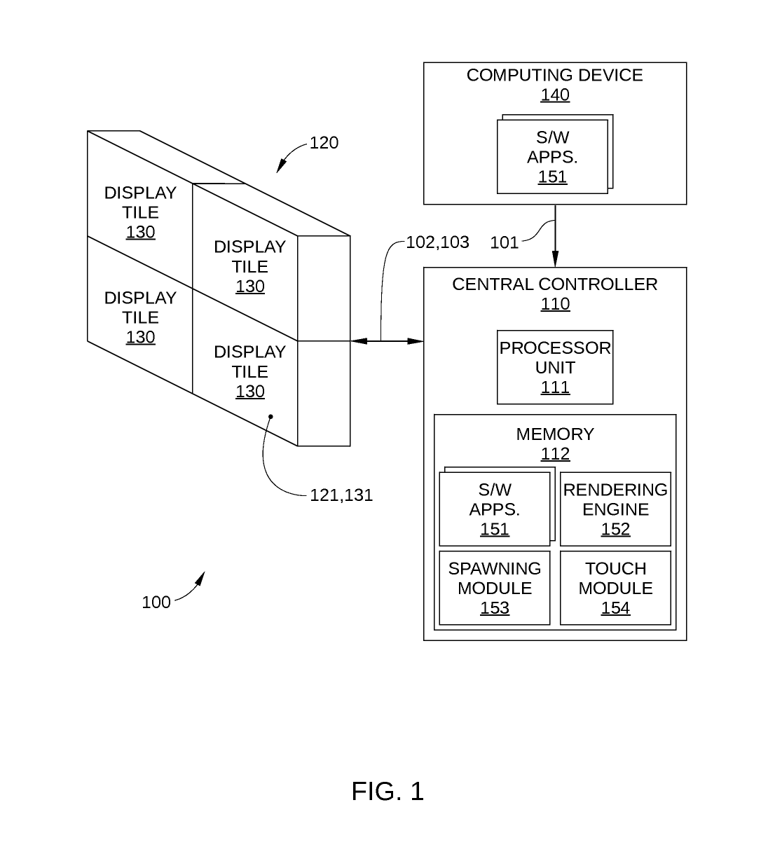

FIG. 1 is a block diagram of a display system 100 configured to implement one or more aspects of the present invention. As shown, display system 100 includes, without limitation, a central controller 110 and a display wall 120. Central controller 110 receives digital image content 101 from a computing device 140 or from an information network or other data routing device, and converts said input into image data signals 102. Thus, digital image content 101 may be generated locally, with computing device 140, or from some other location. For example, when display system 100 is used for remote conferencing, digital image content 101 may be received via any technically feasible communications or information network, wired or wireless, that allows data exchange, such as a wide area network (WAN), a local area network (LAN), a wireless (WiFi) network, and/or the Internet, among others.

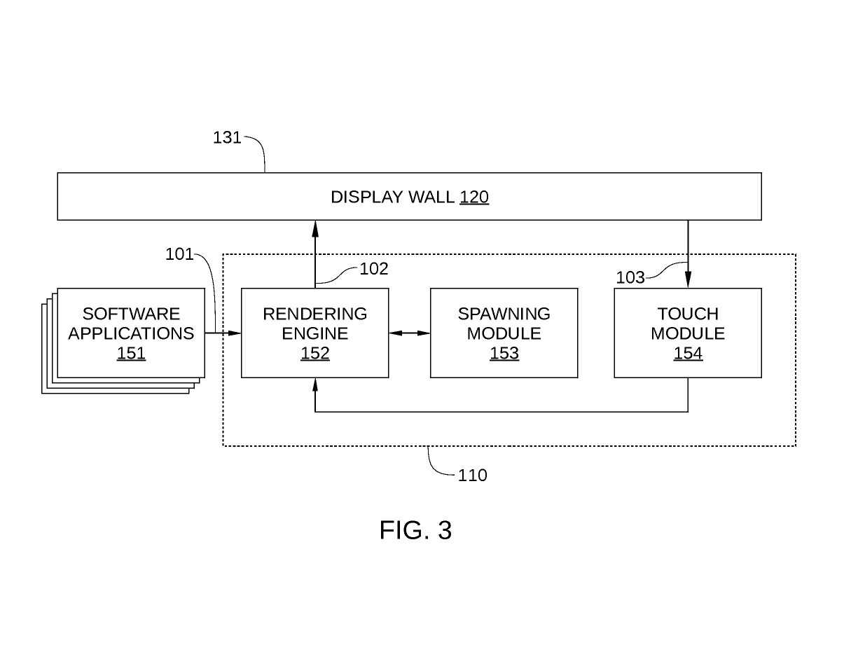

Central controller 110 includes a processor unit 111 and memory 112. Processor unit 111 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processor unit 111 may be any technically feasible hardware unit capable of processing data and/or executing software applications to facilitate operation of display system 100, including software applications 151, rendering engine 152, spawning module 153, and touch module 154. During operation, software applications 151, rendering engine 152, spawning module 153, and touch module 154 may reside in memory 112, and are described below in conjunction with FIG. 3. Alternatively or additionally, software applications 151 may also reside in computing device 140. In some embodiments, one or more of 151-154 may be implemented in firmware, either in central controller 110 and/or in other components of display system 100.

Memory 112 may include volatile memory, such as a random access memory (RAM) module, and non-volatile memory, such as a flash memory unit, a read-only memory (ROM), or a magnetic or optical disk drive, or any other type of memory unit or combination thereof. Memory 112 is configured to store any software programs, operating system, drivers, and the like, that facilitate operation of display system 100, including software applications 151, rendering engine 152, spawning module 153, and touch module 154.

Display wall 120 may include the display surface or surfaces of any technically feasible display device or system type, including but not limited to the display surface of a light-emitting diode (LED) display, a digital light (DLP) or other projection display, a liquid crystal display (LCD), an optical light-emitting diode display (OLED), a laser-phosphor display (LPD), and/or a stereo 3D display, arranged as a single stand-alone display, head mounted display, or as a single or multi-screen tiled array of displays. Display sizes may range from smaller handheld display devices to full wall displays. In the example illustrated in FIG. 1, display wall 120 includes a plurality of display tiles 130 mounted in a 2×2 array. Other configurations and array dimensions of multiple electronic display devices, e.g. 1×4, 2×3, 5×6, etc., also fall within the scope of the present invention.

In operation, display wall 120 displays image data signals 102 output from controller 110 and sends gesture signals 103 to central controller 110 for processing and interpretation. For a tiled display, as illustrated in FIG. 1, image data signals 102 are appropriately distributed among display tiles 130 such that a coherent image is displayed on a display surface 121 of display wall 120. Display surface 121 typically includes the combined display surfaces of display tiles 130. In addition, display wall 120 includes a touch-sensitive or gesture-sensitive surface 131 that extends across the combined surfaces of display tiles 130. Gesture-sensitive surface 131 enables users to interact with assets displayed on the wall using touch gestures including tapping, dragging, swiping, and pinching, in addition to conventional cursor inputs. These touch gestures may replace or supplement the use of typical peripheral I/O devices such as an external keyboard or mouse. Gesture-sensitive surface 131 may be a “multi-touch” surface, which can recognize more than one point of contact on display wall 120, enabling the recognition of complex gestures, such as two or three-finger swipes, pinch gestures, and rotation gestures. Multiple users may also interact with assets on the screen simultaneously. Thus, one or more users may interact with assets on display wall 120 using touch gestures such as dragging to reposition assets on the screen, tapping assets to display menu options, swiping to page through assets, or using pinch gestures to resize assets. Multiple users may also interact with assets on the screen simultaneously. In some embodiments, gesture-sensitive surface 131 may include an array of infra-red beams that, when interrupted, indicate user hand or finger position. In such embodiments, gesture-sensitive surface 131 is not strictly a touch-screen, but effectively operates as one.

An asset may be any interactive renderable content that can be displayed on display wall 120 within a dynamically adjustable presentation window. Examples of assets include application environments, images, videos, web browsers, documents, mirroring or renderings of laptop screens, or presentation slides.

It will be appreciated that the system shown herein is illustrative and that variations and modifications are possible. For example, software applications 151, rendering engine 152, spawning module 153, and touch module 154 may reside outside of central controller 110.

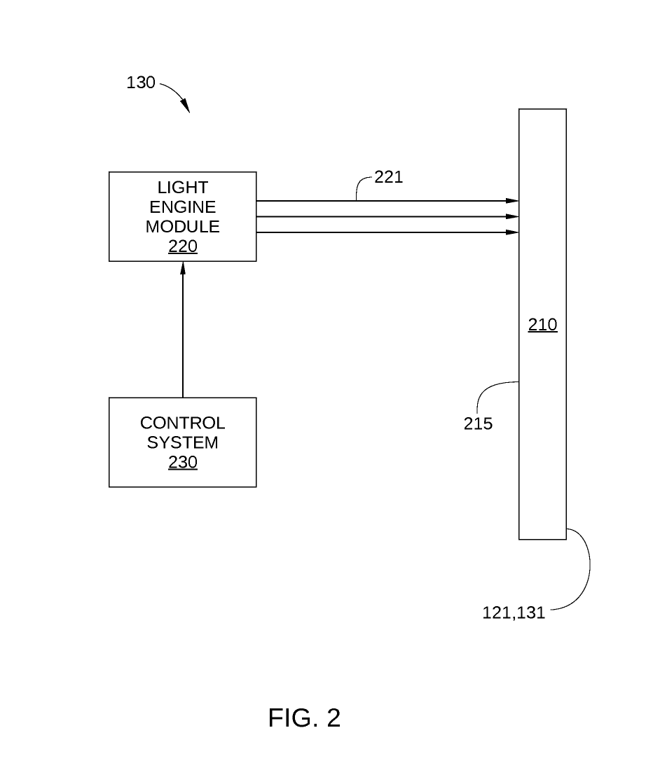

FIG. 2 is a schematic diagram of a display tile 130 configured to implement one or more aspects of the present invention. FIG. 2 is an example configuration only, and any other technically feasible display device suitable for forming display wall 120 may be implemented in alternative embodiments. As shown, display tile 130 includes, without limitation, a display screen region 210, a light engine module 220, and a control system 230. The display screen region 210 is configured to display digital images that are visible to a viewer.

Light engine module 220 is configured to emit one or more scanning beams (e.g., laser beams 221) onto a scan surface 215 of display screen region 210. Display screen region 210 may include a phosphor layer (not shown) that phosphoresces when excited by the optical energy conducted by the one or more laser beams 221, thereby creating visible light. The light engine module 220 is configured to emit one or more laser beams 222 that sweep across the phosphor layer of the display screen region 210 in a pulse width and pulse amplitude modulation manner in order to create visible light that represents an image. The visible light associated with the image emanates through an image surface of the display screen region 210 to a viewer.

The control system 230 is configured to transmit command data to the light engine module 220 to cause light engine module 220 to emit laser beams 221 onto scan surface 215. Control system 230 controls and modulates laser beams 221 emitted by the light engine module 220 so that laser beams 221 are modulated to carry the image to be displayed on scan surface 215. The control system can include a digital image processor that generates digital image signals for three different color channels and laser driver circuits that produce laser control signals carrying the digital image signals. The laser control signals are then applied to modulate the lasers, e.g., the currents for laser diodes.

More detailed descriptions of display devices suitable for being configured as a display tile 130 in display system 100 may be found in US Patent Publication 2014/0307230, published Oct. 16, 2014 and entitled “SELF ALIGNING IMAGER ARRAY” and US Patent Publication 2014/0362300, published Dec. 11, 2014 and entitled “Servo Feedback Control Based on Invisible Scanning Servo Beam in Scanning Beam Display Systems with Light-Emitting Screens.”

FIG. 3 is a block diagram illustrating the operation of display system 100, according to one embodiment of the present invention. As shown, FIG. 3 includes, without limitation, software applications 151, rendering engine 152, spawning module 153, and touch module 154. Software applications 151 generate assets to be displayed on display wall 120. Examples of software applications 151 may include slide show presentation software, word processor software, collaboration design software, image editing software, video player software, remote conferencing applications, and remote desktop clients.

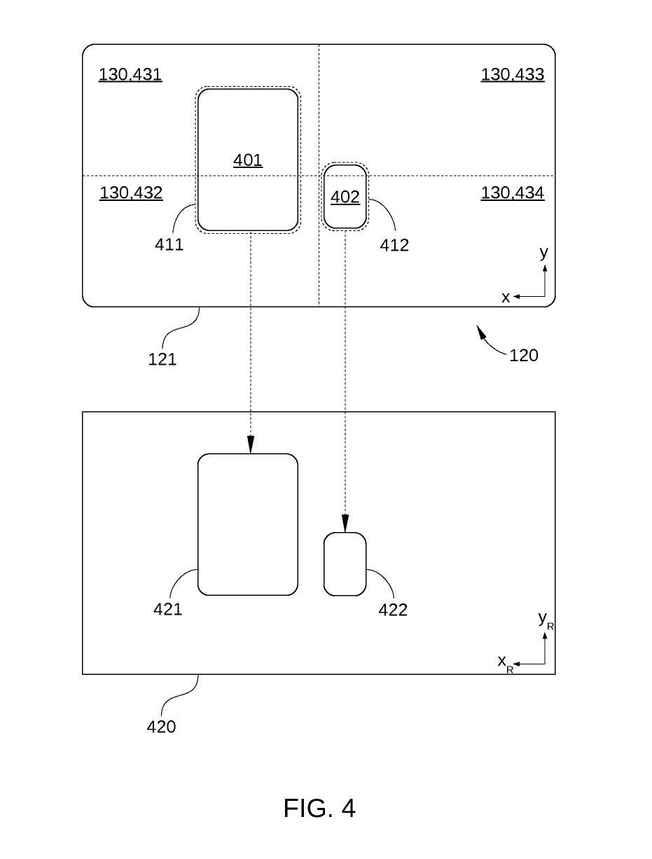

Software applications 151 send digital image content 101 to rendering engine 152. Rendering engine 152 sends image data signals 102 to display wall 120 and is responsible for determining the content that is displayed on each pixel of display wall 120. Rendering engine 152 also manages displayed content by tracking displayed assets and the corresponding software application that generated each asset. Such asset management may be accomplished using the concept of render space, one embodiment of which is described below in conjunction with FIG. 4.

FIG. 4 is a conceptual diagram illustrating display surface 121 of display wall 120 and a corresponding render space 420, according to one embodiment of the present invention. As shown, a parent asset 401 and a spawn asset 402 are displayed on display surface 121 at display locations 411 and 412, respectively. In some embodiments, display location 411 of parent asset 401 and/or display location 412 of spawn asset 402 may extend across one or more display surfaces of display tiles 130. For example, display location 411 may correspond to a portion of a first display tile 431 and to a portion of second display tile 432, while display location 412 may correspond to a portion of a third display tile 433 and to a portion of fourth display tile 434.

The display pixel coordinate system (x,y) of display surface 121 parallels render space 420, which generally resides in memory 112. Thus, each pixel location (x,y) on display surface 121 maps to a location (x_{R},y_{R}) in render space, so that parent asset 401 and spawn asset 402 in display space map to a corresponding parent asset 421 and spawn asset 422 in render space 420. In practice, render space 420 may be a linear construct of data entries in memory 112, instead of a multidimensional mapping as conceptually illustrated in FIG. 4.

Returning to FIG. 3, touch module 154 is responsible for receiving and interpreting gesture signals 103 from gesture-sensitive surface 131 of display wall 120. When a user touches an asset on display wall 120, touch module 154 sends information associated with this touch or gesture event to rendering engine 152. This touch or gesture event information includes the location of the touch or gesture on display surface 131, i.e., the target location, and the type of touch or gesture (e.g., tap, swipe, or pinch). In some embodiments, rendering engine 152 determines whether a new spawn asset should to be displayed on the screen based on the target location and the functionality at the target location of the presentation window associated with the parent asset (e.g., is there a control button located at or near the target location indicating generation of a spawn asset?) In other embodiments, based on the software application associated with the touched asset, rendering engine 152 determines whether a new spawn asset needs to be displayed on the screen. An example of a spawn asset corresponding to the presentation window associated with a parent asset could be a menu window displaying options to modify or annotate the presentation window associated with the parent asset. Furthermore, in some embodiments, a spawn asset can be configured as a parent asset for one or more additional spawn assets. If, in response to the touch or gesture information, one of software applications 151 determines that a new asset is be spawned, rendering engine 152 will communicate with spawning module 153 to determine the optimal location on display wall 120 for displaying such a spawn asset.

In embodiments in which a parent asset is associated with an image or image-related software application, suitable spawn assets include interactive windows that facilitate: taking a snapshot of a portion of display wall 120; sharing an asset with other users; zooming in or out on a portion of the parent asset; annotating the parent asset (possible sub-menus including color selection, line thickness, text insertion, annotation erase, clear all annotations); displaying image metadata; etc. In embodiments in which a parent asset is associated with a video-related software application, suitable spawn assets may be similar to those for image-related parent assets as well as video-specific controls, such as pause, play, scrub, interactive windows that facilitate inserting bookmarks and/or adding captions, etc. In embodiments in which a parent asset is associated with a document-related software application, suitable spawn assets may be similar to image-related spawn assets as well as interactive windows that facilitate paging forward or backward in the parent asset, performing editing functions (e.g., cut, copy, paste), and launching native applications, such as word-processing applications. In embodiments in which a parent asset is associated with a web browser, suitable spawn assets may be similar to image-related spawn assets as well as interactive windows that facilitate entering a URL, navigating the web browser, refreshing the web browser, selecting or editing favorite bookmarks, hiding a URL bar in the web browser, and the like. Other types of parent assets that may have spawn assets associated therewith include but are not limited to whiteboard assets, video conferencing assets, live TV assets, assets for controlling other devices such as lighting or blinds, etc.

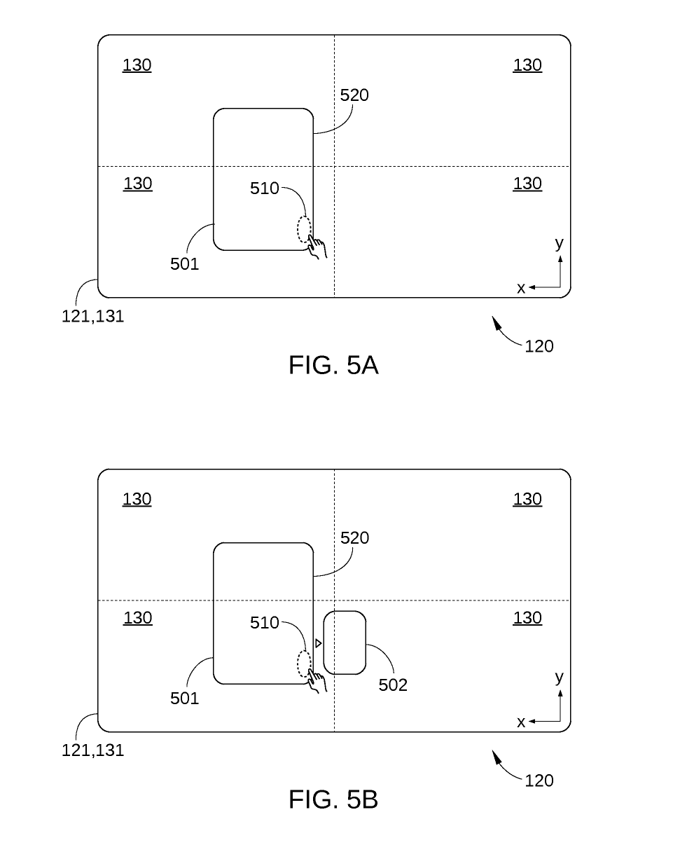

Spawning module 153 determines the optimal location for displaying a spawned asset on display wall 120, based on the location of the touch input, parent asset, and/or other assets on the screen. Various examples of how spawning module 153 determines the display location of a spawned asset are provided below in conjunction with FIGS. 5A-8B.

FIGS. 5A and 5B illustrate an example of the operation of display system 100 in response to user touch or gesture-based input, according to one embodiment of the present invention. In FIG. 5A, a user touches a target location 510 on display surface 121, such as an edge 520 of a parent asset 501 or near edge 520 of parent asset 501, to initiate display of a spawn asset 502. For example, target location 510 may correspond to a region associated with parent asset 501, such as a button for calling up a menu widget, or an edge region of parent asset 501 that is configured as a default menu activation region. Because the touch input is located proximate edge 520 of parent asset 501, which is the rightmost edge of parent asset 501, spawning module 153 notifies rendering engine 152 to display spawn asset 502 to the right of parent asset 501, as shown in FIG. 5B.

In some embodiments, the display location of spawn asset 502 may be selected to be closer to target location 510 than any other edge of parent asset 501. Additional factors that may affect the determination of the display location of spawn asset 502 include personal preference of a particular user (e.g., right or left handed), user location (when available) relative to display surface 121, the vertical and/or horizontal position of target location 510 on display surface 121, proximity of target location 510 to an edge of display surface 121, and the like. Other factors may also be included in determination of the display location of spawn asset 502 without exceeding the scope of the invention.

The placement of spawn asset 502 proximate the touch location, i.e., target location 510, allows a user to interact with spawn asset 502 without obscuring parent asset 501. In addition, the user can access spawn asset 502 without moving to an edge of parent asset 501 that is farther from target location 510 than edge 520. For example, if spawn asset 502 is a menu item giving annotation options for parent asset 501, then the chosen display location shown in FIG. 5B allows a user to interact with the menu item without obscuring the content of the parent asset 501. Additionally, on a large display screen where displayed assets may be as large as or larger than the user, placement of the spawned asset near the location of the user, i.e., proximate target location 510, prevents the user from reaching across a large parent asset or repositioning themselves in a way that obscures the parent asset.

In some embodiments, spawn asset 502 may be an additional parent asset, and therefore be used to generate an additional spawn asset. In such embodiments, the determination of the display location for the additional spawn asset may be similar to the above-described determination of the display location of spawn asset 502. For example, when a user touches or gestures near an additional target location on display surface 121, the display location of the additional spawn asset may be proximate to a first edge of spawn asset 502 that is closer to an additional region in render space associated with the spawn asset 502 (now acting as a parent asset) than any other edge of spawn asset 502, where the additional region in render space corresponds to the additional target location on display surface 121.

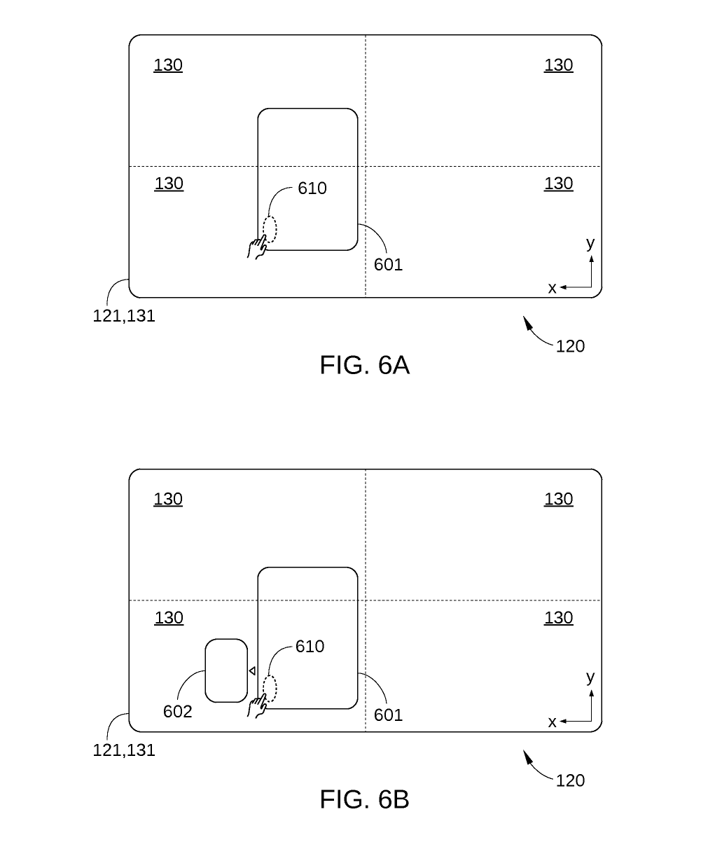

FIGS. 6A and 6B illustrate an example of the operation of display system 100 in response to user touch or gesture-based input, according to another embodiment of the present invention. In FIG. 6A, a user touches a target location 610 on display surface 121 that is disposed on the left side of a parent asset 601 to initiate display of a spawn asset 602. Because the touch input is located on the left side of parent asset 601, spawning module 153 will notify rendering engine 152 to display spawn asset 602 to the left of parent asset 601, as shown in FIG. 6B. This asset placement allows a user to interact with the spawned asset without obscuring the parent asset or moving to the far side of parent asset 601 to interact with content in spawned asset 602. Thus, the placement of spawn asset 602 relative to parent asset 601 is not predetermined, and may vary depending on the location of target location 610.

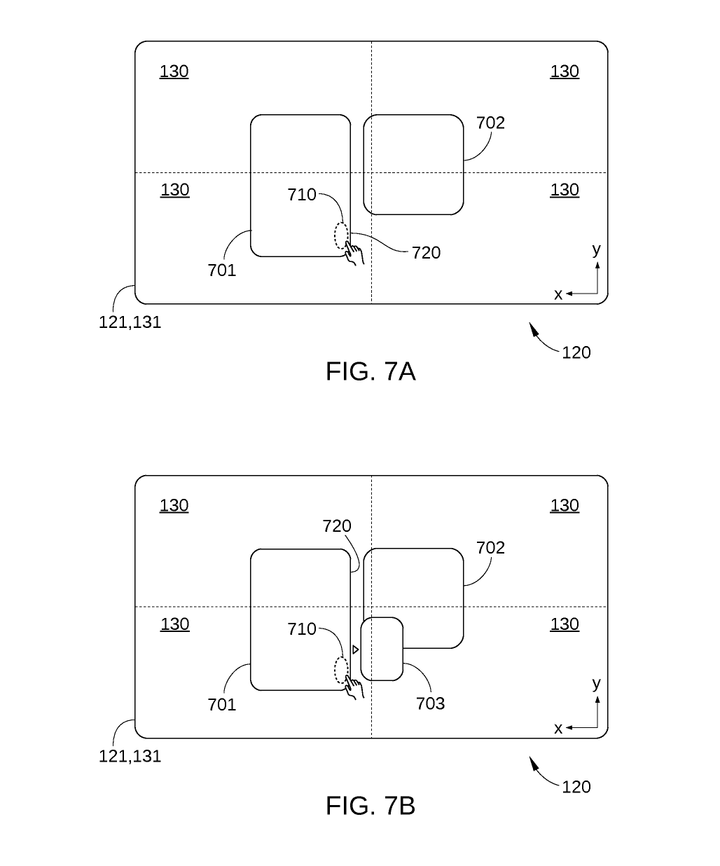

FIGS. 7A and 7B illustrate the operation of display system 100 when an active asset 701 and an inactive asset 702 are displayed thereby, according to an embodiment. Inactive asset 702 may be any asset not currently in use, as defined by the user or software. When a user touches active parent asset 701 at a target location 710 to initiate display of spawn asset 703, spawning module 153 will notify rendering engine 152 to display spawn asset 703 proximate to edge 720, which is the edge of active parent asset 701 that is closer to target location 710 than any other edge of active parent asset 701. This display location choice places spawn asset 703 in a location convenient for the user so that active asset 701 is not obstructed, as described previously in FIGS. 5A and 5B. However, spawn asset 703 is allowed to partially or completely obscure asset 702, because asset 702 is inactive.

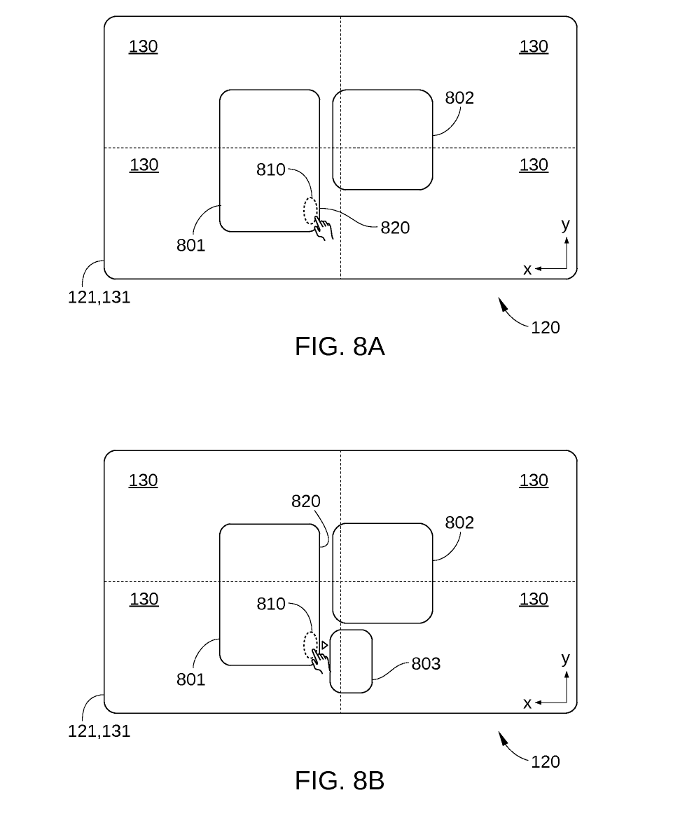

FIGS. 8A and 8B illustrate the operation of display system 100 when multiple active assets are displayed thereby, according to an embodiment. In FIG. 8A, a user touches an active parent asset 801 to initiate display of spawn asset 803. As shown, a user touches display surface 121 at a touch location 810 that is closer to an edge 820 of active parent asset 801 than any other edge of active parent asset 801. Spawning module 153 notifies rendering engine 152 to display spawn asset 803 at a location that is proximate to edge 820 and does not overlap with an active asset 802 (or any other active assets being displayed by display system 100). Thus, in some embodiments, rendering engine 152 determines the spawn location of spawn asset 803 in render space so that the spawn location of spawn asset 803 does not overlap any portion of any active asset that is currently displayed. In such embodiments, the display location of spawn asset 803 is selected so that a user can conveniently access spawn asset 803 without obscuring either active asset 801 or 802.

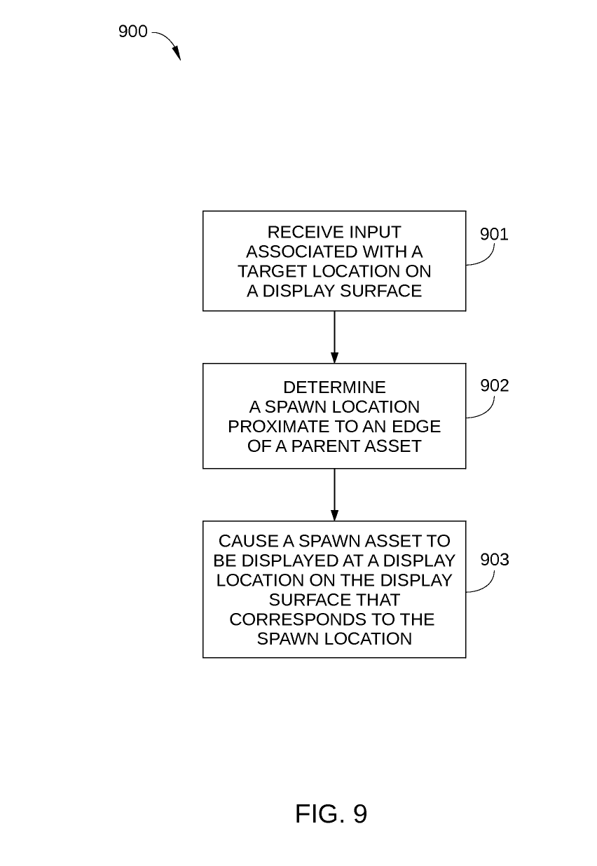

FIG. 9 sets forth a flowchart of method steps for displaying content on a display surface, according to one embodiment of the present invention. Although the method steps are described with respect to the systems of FIGS. 1-8B, persons skilled in the art will understand that any system configured to perform the method steps, in any order, falls within the scope of the present invention.

As shown, a method 900 begins at step 901, in which central controller 110 receives an input associated with a target location on display surface 121. In some embodiments, the target location includes a touch location. In such embodiments, the input may be generated by a touch module, and is based on a touch input to the target location on a gesture-sensitive surface associated with display surface 121. In other embodiments, the input received in step 901 may be generated based on, for example, a cursor selection input at the target location. The target location corresponds to a region associated with a parent asset that resides at least partially within a render space, e.g., render space 420 in FIG. 4, and is displayed at a first display location on the display surface. In some embodiments, the display surface may include multiple display screens that are adjacent to each other. In some embodiments, the first display location may extend across multiple display surfaces.

In step 902, in response to receiving the input, central controller 110 determines a spawn location within the render space in which the parent asset resides. In some embodiments, central controller 110 determines the spawn location within the render space from one or more possible spawn locations that are available and are associated with the parent asset and the target location. In some embodiments, an available portion of the render space does not include a portion of an active asset or an edge of the render space. Thus, when the spawn location is determined in this fashion, the spawn location may be selected to avoid overlapping with any edge of display surface 121, so that the entire spawn asset will be displayed thereon, or any active assets, so that the active assets are not obscured. In other embodiments, the spawn location may overlap a portion of the parent asset, but not of any other active assets. Furthermore, the spawn asset may be positioned and/or resized based on the available portion of the render space.

In some embodiments, central controller 110 determines a spawn location that is a region of the render space that does not include any portion of any displayed asset. Thus, in such embodiments, the spawn asset does not obscure any other assets when displayed. In other embodiments, central controller 110 determines a spawn location that is a region of the render space that does not include any portion of any active assets. Thus, in such embodiments, the spawn asset only obscures inactive assets, such as assets that have received no user interaction over a predetermined time interval or that have been indicated via user interaction to be inactive. In yet other embodiments, the central controller 110 determines a spawn location that is a region of the render space that does not include any portion of any active assets except for the parent asset. Thus, in such embodiments, the spawn asset may at least partially overlap some or all of the parent asset, but no other active assets.

In some embodiments, the spawn location is a region of the render space that is proximate a region of the render space that corresponds to the target location. More specifically, in some embodiments, the spawn location may be a region of the render space that is proximate an edge of the parent asset that is closer to the region that corresponds to the target location than any other edge of the parent asset. Thus, in such embodiments, the spawn location will be on a side or edge of a parent asset that is closest to the target location at which a user generated the touch input that initiated the spawn asset. The edge of the parent asset that is closer to the region that corresponds to the target location than any other edge of the parent asset may be a side, top, or bottom edge.

In step 903, central controller 110 causes the spawn asset to be displayed at a second display location on the display surface that corresponds to the spawn location. Because the spawn location is selected to be proximate the region of the render space that corresponds to the target location described in step 901, the spawn asset is displayed close to the user who initiated generation of the spawn asset.

In sum, embodiments of the invention set forth various approaches to displaying assets on large multi-touch screens. Based on the location of user touch input relative to a touched asset and/or other assets currently displayed on a display surface, a display system can optimally position new assets to avoid obscuring the currently displayed content. Among other things, the disclosed approaches advantageously allow menus and assets to be displayed at locations that avoid obscuring previously displayed assets and prevent a user from obscuring displayed assets with his/her body when interacting with assets via touch gestures.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

The claimed invention is:

1. A method for displaying content on a display surface, the method comprising:
receiving an input associated with a target location on the display surface corresponding to a region associated with a parent asset that resides at least partially within a render space and is displayed at a first display location on the display surface;
in response to receiving the input, determining a first spawn location within the render space from one or more possible spawn locations that are available and are associated with the parent asset and the target location; and
causing a spawn asset to be displayed at a second display location on the display surface that corresponds to the first spawn location,
wherein the first spawn location is closer to a first edge of the parent asset than any of the other one or more possible spawn locations.

2. The method of claim 1, wherein the display surface includes a first display screen of a first display device and a second display screen of a second display device that is adjacent to the first display screen.

3. The method of claim 2, wherein the first display location corresponds to a first portion of the first display screen and to a second portion of the second display screen.

4. The method of claim 1, wherein determining the first spawn location comprises selecting a region of the render space that does not include any portion of any displayed asset.

5. A non-transitory computer readable medium storing instructions that, when executed by a processor, cause the processor to display content on a display surface, by performing the steps of:
receiving an input associated with a target location on the display surface corresponding to a region associated with a parent asset that resides at least partially within a render space and is displayed at a first display location on the display surface;
in response to receiving the input, determining a first spawn location within the render space from one or more possible spawn locations that are available and are associated with the parent asset and the target location; and
causing a spawn asset to be displayed at a second display location on the display surface that corresponds to the first spawn location,
wherein the first spawn location is closer to a first edge of the parent asset than any of the other one or more possible spawn locations.

6. The non-transitory computer readable medium of claim 5, wherein determining the first spawn location comprises selecting an available portion of the render space that does not include a portion of an active asset.

7. The non-transitory computer readable medium of claim 5, wherein the display surface includes a first display screen of a first display device and a second display screen of a second display device that is adjacent to the first display screen.

8. The non-transitory computer readable medium of claim 7, wherein the first display location corresponds to a first portion of the first display screen and to a second portion of the second display screen.

9. The non-transitory computer readable medium of claim 5, wherein determining the first spawn location comprises selecting a region of the render space that does not include any portion of any displayed asset.

10. The non-transitory computer readable medium of claim 5, wherein determining the first spawn location comprises selecting a region of the render space that does not include any portion of any active displayed asset.

11. The non-transitory computer readable medium of claim 10, wherein determining the first spawn location comprises selecting a region of the render space that includes at least a portion of an inactive displayed asset.

12. The non-transitory computer readable medium of claim 5, wherein determining the first spawn location comprises selecting a region of the render space that does not include any portion of any active displayed asset except for the parent asset.

13. The non-transitory computer readable medium of claim 5, wherein the parent asset comprises a window of a graphical user interface associated with an application program, and the spawn asset comprises a graphical control element of the graphical user interface.

14. The non-transitory computer readable medium of claim 5, wherein the spawn asset comprises an additional parent asset for an additional spawn asset, and a display location for the additional spawn asset is proximate to a first edge of the additional parent asset that is closer to an additional region in the render space associated with the additional parent asset than any other edge of the additional parent asset, the additional region in the render space corresponding to an additional target location on the display surface.

15. The non-transitory computer readable medium of claim 5, further comprising instructions that, when executed by the processor, cause the processor to perform the step of generating the spawn asset in response to receiving the input.

16. The non-transitory computer readable medium of claim 15, wherein an application program generates both the parent asset and the spawn asset.

17. The non-transitory computer readable medium of claim 5, wherein the target location is one of a touch location, gesture location, or a cursor-indicated location.

18. The non-transitory computer readable medium of claim 5, wherein the first spawn location does not overlap the parent asset within the render space.

19. The non-transitory computer readable medium of claim 5, wherein the region associated with the parent asset is disposed within a boundary of the parent asset.

20. A display system, comprising:
a gesture-sensitive display surface configured to generate a position signal associated with a target location corresponding to a region associated with a parent asset that resides at least partially within a render space and is displayed at a first display location on the display surface; and
a processor configured to:
receive the position signal,
in response to receiving the position signal, determine a first spawn location within the render space from one or more possible spawn locations that are available and are associated with the parent asset and the target location, and
cause a spawn asset to be displayed at a second display location on the display surface that corresponds to the first spawn location,
wherein the first spawn location is closer to a first edge of the parent asset than any of the other one or more possible spawn locations.
